(19) United States
(12) Patent Application Publication
(10) Pub. No.: US 2026/0288158 A1
(43) Pub. Date: Sep. 24, 2026

(54) SYSTEM AND METHOD OF APPROXIMATE ENVIRONMENT DECOMPOSITIONS FOR ROBOT COVERAGE PLANNING USING SUBMODULAR COVER

(71) Applicant: Avidbots Corp, Kitchener (CA)

(72) Inventors: Megnath RAMESH, Waterloo (CA); Francis Christopher IMESON, Kitchener (CA); Stephen SMITH, Kitchener (CA); Baris FIDAN, Kitchener (CA)

(21) Appl. No.: 19/570,351

(22) Filed: Mar. 18, 2026

Related U.S. Application Data
(60) Provisional application No. 63/774,216, filed on Mar. 19, 2025.

(51) Int. Cl. G05D 1/648; G05D 1/622; G05D 1/644; G05D 105/10; G05D 105/15; G05D 109/10

(52) U.S. Cl. CPC G05D 1/6484; G05D 1/622; G05D 1/644; G05D 2105/10; G05D 2105/15; G05D 2109/10

(57) ABSTRACT

A system and method to approximate environment decomposition for robot coverage planning using submodular cover is disclosed. Coverage planning is the task of computing a path for a robot carrying a coverage or sensing tool such that the tool visits all points in the environment. Decompositions of the environment are used in coverage planning to identify sub-regions that can each be optimally covered using a lawnmower path (i.e., a zig-zag path through parallel straight lines) along a single orientation. However, existing approaches make simplifying assumptions, such as fixing the direction of decomposition, and provide no optimality guarantees. An approach to decompose the environment into the minimum number of sectors, which are (possibly intersecting) sub-regions for which the orientations of the lawnmower paths are clearly defined is disclosed. Coverage paths are generated for real-world environments using this approach and show improvements over state-of-the-art coverage planning approaches.

### CROSS-REFERENCE TO RELATED APPLICATIONS

This application claims the benefit of and priority to U.S. Provisional Patent Application No. 63/774,216, filed Mar. 19, 2025, entitled “SYSTEM AND METHOD OF APPROXIMATE ENVIRONMENT DECOMPOSITIONS FOR ROBOT COVERAGE PLANNING USING SUBMODULAR COVER,” the entire contents of which are incorporated by reference herein.

### BACKGROUND

The present disclosure relates to robotic coverage planning and, more particularly, to systems and methods for decomposing a two-dimensional environment into coverable sub-regions to enable efficient coverage path planning.

Autonomous and semi-autonomous robots (e.g., cleaning robots) often need to traverse an environment so that a coverage or sensing tool visits points of interest in the environment. Coverage path planning (CPP) is generally computationally hard and practical approaches commonly use a two-step framework: decompose the environment into sub-regions (sectors) and compute a visitation order or tour among the sectors.

Existing approaches can suffer from one or more limitations, including: over-decomposition in complex environments with irregular boundaries (creating thin regions and excessive double coverage), constraining coverage orientations to axis-parallel directions (creating staircase-like paths), and lacking useful guarantees on the number of sectors produced.

Accordingly, there is a need for improved decomposition techniques that reduce over-decomposition, enable multiple coverage orientations, and provide practical approximation properties.

### SUMMARY

Disclosed are systems and methods for approximate environment decomposition for robot coverage planning. In various embodiments, an environment is decomposed into a set of rectangular sectors (which may be non-overlapping or may overlap in a controlled manner). A sector coverage function (e.g., an area-of-union measure over sectors) is leveraged, including its submodular property, to formulate the decomposition as a submodular set cover problem. A greedy selection process iteratively selects sectors to cover new area until a target minimum coverage ratio is achieved. In some embodiments, overlap is controlled using an erosion radius parameter (e.g., via a Minkowski difference operation) and/or the resulting decomposition is reduced using local sector merges. After decomposition, coverage paths may be generated using sector touring, including selecting lawnmower paths per sector and computing transitions among sectors (e.g., using GTSP and/or visibility-graph-based planning).

### BRIEF DESCRIPTION OF THE DRAWINGS

FIG. 1 illustrates an example coverage path resulting from an environment decomposition containing multiple sectors, where each sector is covered by a lawnmower path and the robot transitions between sectors using intra-sector and inter-sector paths.

FIG. 2 illustrates example G-Sect results with varying sector overlap and merging.

FIG. 3 illustrates sector decomposition results for test maps.

FIG. 4 illustrates an example greedy sector decomposition (G-Sect) algorithm.

FIG. 5A illustrates example robot parameters used for experiments.

FIG. 5B illustrates a comparison of a number of sectors for different decompositions.

FIG. 5C illustrates a comparison of coverage planning performance for test maps.

### DETAILED DESCRIPTION

### Overview

In various embodiments, the system decomposes an environment (e.g., an indoor environment) into sectors, where each sector is a sub-region that can be covered using a lawnmower path (parallel straight-line coverage segments connected by short turns). Rectangular sectors are particularly useful because a lawnmower path can be oriented along a rectangle's longest edge and rectangular regions can be identified efficiently under certain constraints.

The decomposition may be configured to cover the entire environment or to cover at least a minimum coverage ratio (e.g., γ of total environment area) to reduce over-decomposition and avoid small inaccessible pockets.

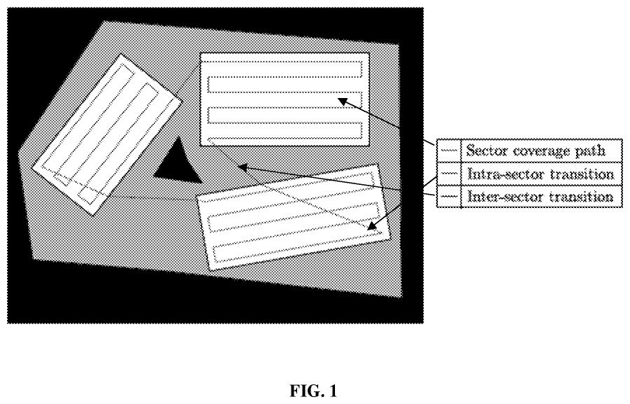

FIG. 1 illustrates an example coverage path resulting from an environment decomposition containing multiple sectors, where each sector is covered by a lawnmower path and the robot transitions between sectors using intra-sector and inter-sector paths. According to the disclosure, FIG. 1 depicts a coverage plan generated from a decomposition of an environment into multiple sectors (example: three sectors).

According to FIG. 1, Each sector is associated with a lawnmower path (parallel coverage lines) and the complete robot trajectory further includes intra-sector motions (motions inside a sector to connect endpoints of the lawnmower path to designated sector points such as corners), and inter-sector motions (motions between sectors). Furthermore, FIG. 1 supports embodiments where the system first decomposes the environment into sectors and then generates a tour connecting sector coverage trajectories.

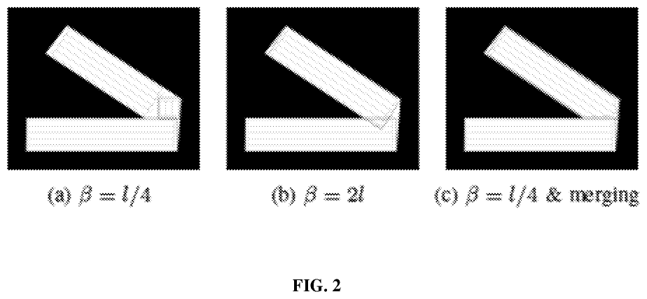

FIG. 2 illustrates example G-Sect results with varying sector overlap and merging. According to the disclosure, FIG. 2 depicts example decompositions generated by G-Sect for different overlap settings and with/without local merging. The disclosure explains that increasing overlap (via a larger erosion radius β) may reduce the number of sectors but can increase double coverage (overlapping coverage lines), and that a small amount of overlap combined with local merges can reduce sector count while avoiding overlapping coverage lines in some examples.

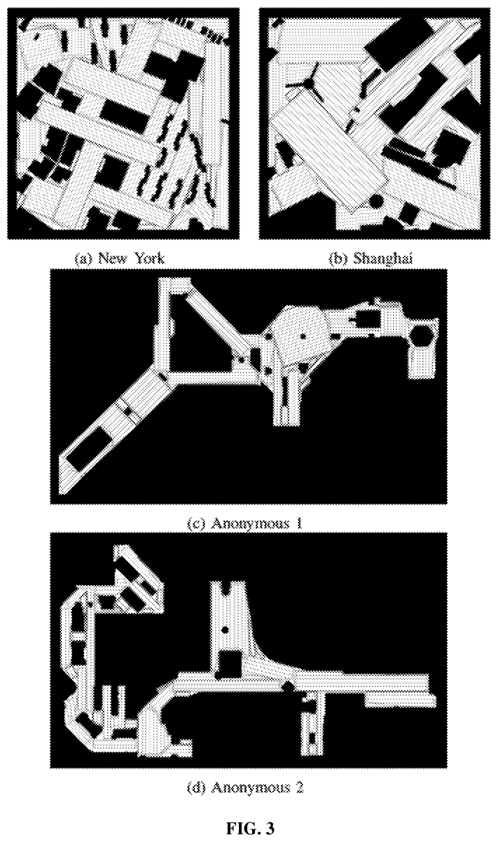

FIG. 3 illustrates sector decomposition results for test maps. According to the disclosure, FIG. 3 depicts example sector decompositions for multiple test maps. These decompositions yield “intuitive coverage lines,” including in narrow regions where coverage lines align with environment edges (i.e., supporting multi-orientation behavior rather than axis-parallel-only).

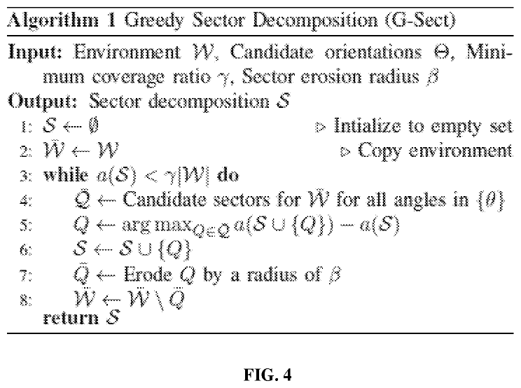

FIG. 4 illustrates an example greedy sector decomposition (G-Sect) algorithm. According to the disclosure, FIG. 4 illustrates an exemplary greedy algorithm that repeatedly computes candidate sectors (e.g., one per candidate orientation) and adds a sector that covers the largest remaining uncovered area until a minimum coverage ratio γ is achieved. It also supports embodiments that remove either the entire selected sector (non-overlap) or an eroded form of the sector based on β (controlled overlap).

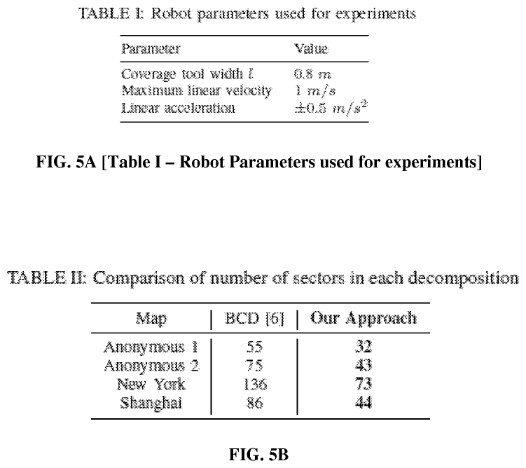

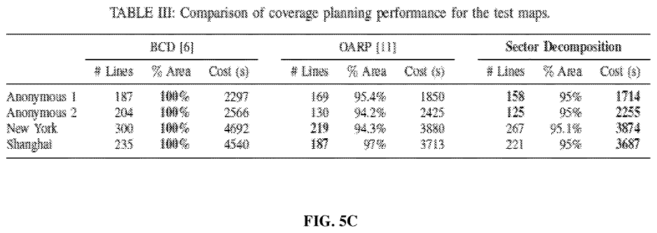

FIG. 5A illustrates example robot parameters used for experiments. According to the disclosure, FIG. 5A is a table listing example robot parameters used in experiments, including a coverage tool width l and motion parameters used for time-based edge costs (e.g., maximum velocity and acceleration settings). It supports embodiments where the planner computes transition costs using a robot motion model (e.g., piecewise constant acceleration until maximum velocity).

FIG. 5B illustrates a comparison of a number of sectors for different decompositions. According to the disclosure, FIG. 5B is a table comparing number of sectors produced by different decomposition approaches, supporting the benefit that the disclosed approach can reduce sector count (e.g., via minimum coverage ratio γ and/or sector merges) relative to exact decompositions that may over-decompose in complex environments.

FIG. 5C illustrates a comparison of coverage planning performance for test maps. According to the disclosure, FIG. 5C is a table comparing performance metrics (e.g., number of coverage lines, percent area covered, and overall coverage path cost) across decomposition/planning approaches, supporting embodiments where the disclosed decomposition yields lower cost due to more appropriate coverage orientations and transitions.

### System Context and Inputs

In embodiments, a robot coverage planning system receives or maintains an environment representation of a two-dimensional workspace W (e.g., free space bounded by walls and containing obstacles/holes). The robot includes a coverage or sensing tool having an effective coverage width l, which may be modeled as a square footprint of width l for planning purposes.

The system seeks to generate a coverage plan that visits (all or substantially all) points in W by:
decomposing W into sub-regions (“sectors”) each coverable by a lawnmower pattern, and
generating a tour through the sectors and connecting the sector coverage motions into a complete trajectory. An example of these components is illustrated in FIG. 1, including intra-sector and inter-sector transition paths.

### Sector Model

Sectors are described primarily as rectangular subsets of W. Rectangles are selected in the disclosure because an optimal lawnmower orientation for a rectangle can be aligned along the rectangle's longest edge, and large rectangles can be identified efficiently in polygonal environments using known computational geometry techniques (including axis-parallel rectangles after rotation into a candidate frame).

The disclosure also notes that more generally a sector could be a monotone region having a well-defined coverage orientation; however, the described implementations emphasize rectangles and leverage efficient largest-inscribed-rectangle computation at candidate orientations.

### Environment Representation

Let an environment be represented as a two-dimensional set W⊆R\hat{ }2, such as a polygonal free-space region derived from a map. The robot has a coverage tool (e.g., cleaning head, brush, sensor footprint) that covers a swath of width l. In some embodiments, the tool footprint is approximated as a square of width l.

### Candidate Sectors and Orientation Set

Let Q denote a set of candidate sectors, where each candidate sector Q_i∈Q corresponds to a rectangle contained within W, optionally oriented by an angle Θi∈(0,π). In some implementations, a finite set of candidate orientations Θ is generated from environment features (e.g., wall-edge orientations), and candidate sectors are constrained to orientations in Θ.

In embodiments, the system derives a finite set of candidate orientations Θ from the environment's geometry (e.g., orientations of boundary edges and hole edges), and constrains candidate sectors to rectangles oriented along angles in Θ. For each orientation θ∈Θ, the system may compute the largest axis-parallel rectangle in the coordinate frame rotated by θ, yielding a set of candidate sectors from which a “best” candidate can be chosen at each greedy iteration.

### Minimum Coverage Ratio γ (Avoiding Over-Decomposition)

According to the disclosure, to reduce over-decomposition (e.g., many small sectors capturing narrow or inaccessible pockets), the system uses a minimum coverage ratio γ ∈(0,1] and computes a decomposition whose sector union covers at least γ|W|rather than necessarily all of W. This permits the greedy method to stop once substantial coverage is achieved, which empirically reduces sector count and avoids thin sectors that may be smaller than the tool width l.

### Sector Coverage Function and Submodularity

For a subset S⊆Q, define a coverage measure as the area of the union of sectors in Sintersected with W. The area-of-union coverage function can be normalized, monotone, and submodular, enabling a submodular set cover formulation. This supports the use of greedy selection with known approximation behavior in many settings.

Let Q denote a (possibly large, even uncountably infinite) set of candidate rectangles within W. Define a coverage function a(S) measuring the area of the union of sectors in S (as intersected with W). The disclosure establishes that the coverage function can be treated as normalized, monotone, and submodular, which links the sector decomposition objective to submodular set cover (SSC) and enables greedy selection behavior with known approximation guarantees (particularly in the unconstrained-overlap case).

### Sector Decomposition Objective

Given W, candidate sectors Q, and a minimum coverage ratio ├γ∈(0,1)=, the system computes a decomposition S⊆Q such that the covered area is at least γ|W| while favoring a smaller number of sectors (and, in some embodiments, limiting overlap).

### Greedy Sector Decomposition (G-Sect)

In one embodiment, the system iteratively selects sectors that maximize newly covered area until the minimum coverage ratio is met. An example pseudocode is shown in FIG. 4.

FIG. 4 illustrates an exemplary greedy process (“G-Sect” or greedy sector decomposition (G-Sect) algorithm). According to FIG. 4, the algorithm maintains a current “remaining” subset of W that is uncovered (or not yet removed), and iteratively:
computes a candidate sector for each candidate orientation θ∈Θ,
selects the candidate sector having the largest area (or largest marginal newly covered area),
adds the selected sector to the decomposition S, and
removes covered area from the remaining environment representation, repeating until the minimum coverage ratio γ is met.

### Optional Overlap Control Using Erosion Radius β (Minkowski Difference)

The disclosure further explains that allowing some overlap can produce better-fitting neighboring sectors. To enable controlled overlap, embodiments use a sector erosion radius β and remove from the remaining environment not the full selected sector Q, but an eroded version (e.g., a Minkowski difference between Q and a disk of radius β). This allows future sectors to overlap Q within a bound dependent on β. Setting β=0 yields truly non-overlapping sectors; larger β yields greater overlap (and potentially unconstrained overlap for very large β).

FIG. 2 illustrates example results for different β values and discusses the tradeoff between fewer sectors and increased double coverage when overlap becomes too large. According to FIG. 2, The rectangular sectors will determine the cleaning rows at different parts of the environment, which are then connected to obtain the cleaning path for the robot. The path is then sent to the robot's hardware/processor to be executed.

### Local Sector Merges

According to the disclosure, after greedy selection, the system may perform local merges to reduce the number of sectors further. The disclosure describes iterating sectors from smallest to largest and, for each sector Q, identifying an adjacent sector Q_adj with orientation θ_adj such that the number of coverage lines needed to cover Q∪Q_adj along θ_adj is less than or equal to the sum of lines required to cover Q and Q_adj separately. Ties may be broken in favor of larger-area adjacent sectors.

The merged sector is added back and the process repeats until no further merges are available. The disclosure notes merges may yield non-rectangular sectors, though they retain the key constraint that each sector remains coverable by a lawnmower path; alternatively, merges can be skipped to keep strictly rectangular sectors.

### Sector Touring and Coverage Path Generation (Lawnmower Paths)

For each sector, the system generates a lawnmower path consisting of parallel coverage lines separated by approximately the tool width l. The disclosure describes that there may be two possible lawnmower paths depending on how adjacent lines are connected, and each can be traversed in two directions (supporting multiple directed variants per sector). Once a decomposition is obtained, a coverage path may be generated by:
selecting a lawnmower path for each sector (including entry/exit choices and traversal direction), and
computing transition paths between sectors (e.g., inter-sector and intra-sector transitions as illustrated in FIG. 1).

### Sector Touring via GTSP

In some embodiments, the tour is computed as a generalized traveling salesperson problem (GTSP) over candidate entry/exit nodes associated with each sector, and transition costs are computed using obstacle-aware planning (e.g., a visibility graph planner).

To connect sectors into one overall plan, embodiments perform sector touring. The disclosure describes formulating a GTSP to minimize time to cover all sectors by simultaneously choosing:
visitation order of sectors, and
entry and exit points (determined by the chosen directed lawnmower traversal for each sector).

An auxiliary graph is created where each sector corresponds to a group of up to four vertices representing directed sector-coverage traversals (two lawnmower variants×two traversal directions). Edges between vertices represent transition paths between sector endpoints.

### Transition Planning and Cost Modeling

In embodiments, transition edges are computed by finding an obstacle-free path between endpoints using a visibility-graph planner, and then assigning a cost based on travel time computed with a piecewise constant acceleration model (accelerate along straight segments until reaching maximum velocity). The disclosure also notes that even if turning is not explicitly penalized, the motion model penalizes stopping for turns, and the resulting GTSP tour provides a full coverage path as a series of connected sectors.

### Computing System Implementation

The disclosed methods may be implemented using one or more processors and memory storing instructions that, when executed, perform environment decomposition, sector selection, overlap control, merges, and/or coverage tour computation. Inputs may include an environment map (e.g., polygon representation), robot/tool parameters (e.g., tool width l), and configuration parameters (e.g., γ, Θ, β). Outputs may include the sector set, sector orientations, coverage lines, and/or a full robot trajectory.

According to the disclosure a method for generating a decomposition of an environment for robot coverage planning is disclosed. The method comprises the steps of obtaining an environment representation defining a coverable region in a two-dimensional workspace, obtaining a coverage tool width associated with a robot configured to traverse the environment, obtaining a plurality of candidate orientations for coverage, generating, for at least one of the candidate orientations, a plurality of candidate rectangular sectors each contained within the coverable region and oriented according to the candidate orientation, iteratively selecting, by one or more processors, candidate rectangular sectors to form a sector set by repeatedly choosing a candidate rectangular sector that maximizes a marginal increase in a sector coverage function representing area of the environment covered by a union of sectors in the sector set, and terminating the iteratively selecting when the sector coverage function indicates coverage of at least a minimum coverage ratio of the environment.

According to the disclosure, the sector coverage function is submodular with respect to the candidate rectangular sectors. the minimum coverage ratio is a parameter γ∈(0,1]and terminating comprises terminating when covered area is at least γtimes a total area of the environment.

According to the disclosure, the plurality of candidate orientations includes orientations derived from edges of boundaries or obstacles in the environment representation. Generating the plurality of candidate rectangular sectors comprises, for each candidate orientation, computing a largest-area rectangular sector inside the environment at the candidate orientation.

According to the disclosure, iteratively selecting comprises recomputing candidate rectangular sectors relative to a remaining uncovered portion of the environment. The method further comprising controlling overlap between sectors using an erosion radius parameter β.

According to the disclosure, controlling overlap comprises removing from a remaining-environment set a Minkowski difference of a selected sector and a disk having radius β, such that subsequently selected sectors are permitted to overlap the selected sector by an amount based on β whereby β=0 causes the selected sectors to be non-overlapping.

According to the disclosure, the method further comprises after forming the sector set, performing local merges among at least two neighboring sectors to reduce a number of sectors. The method wherein performing local merges comprises selecting a first sector and a second sector and merging the first sector into the second sector when a number of coverage lines required to cover a union of the first and second sectors along an orientation of the second sector is less than or equal to a sum of coverage lines required to cover the first sector and the second sector individually.

According to the disclosure, the method further comprises generating, for each selected sector, a lawnmower coverage path comprising parallel coverage lines oriented along a longest edge of the selected sector. The method further comprises selecting, for at least one selected sector, one of two alternative lawnmower traversal patterns that differ in connections between coverage lines.

According to the disclosure, the method further comprises generating a coverage tour that connects lawnmower coverage paths of the selected sectors. Generating the coverage tour comprises formulating a generalized traveling salesperson problem (GTSP) in which each sector corresponds to a group of vertices representing candidate directed sector-coverage traversals.

According to the disclosure, the method further comprises computing at least one transition path between an end of a lawnmower coverage path in a first sector and an end of a lawnmower coverage path in a second sector using obstacle-aware planning. The obstacle-aware planning comprises visibility-graph planning.

According to the disclosure, the method, further comprises computing transition costs using a robot motion model that penalizes stopping and turning by modeling piecewise acceleration toward a maximum velocity. The environment representation comprises a polygonal free-space representation including boundaries and holes corresponding to obstacles.

According to the disclosure, the robot is a cleaning robot and the coverage tool width corresponds to a cleaning head width.

According to the disclosure a system for robot coverage planning is disclosed. The system comprises one or more processors and one or more non-transitory memories storing instructions that, when executed by the one or more processors, cause the system to obtain an environment representation defining a coverable region in a two-dimensional workspace, obtain a coverage tool width associated with a robot, obtain a plurality of candidate orientations, generate candidate rectangular sectors oriented according to the plurality of candidate orientations and contained within the coverable region, select a sector set by iteratively adding a candidate rectangular sector that maximizes a marginal increase in a submodular sector coverage function corresponding to covered area of a union of sectors in the sector set and stop the iteratively adding when the sector set covers at least a minimum coverage ratio of the environment.

According to the disclosure the instructions of the system further cause the system to control overlap between sectors using an erosion radius parameter and to permit limited overlap based on the erosion radius. The instructions further cause the system to merge neighboring sectors after selection to reduce a number of sectors in the sector set.

According to the disclosure, the instructions further cause the system to generate a lawnmower path for each sector and to compute a tour connecting the lawnmower paths. The tour is computed using a generalized traveling salesperson problem over candidate entry and exit points for each sector.

According to the disclosure the system further comprises the robot, wherein the robot comprises a controller configured to execute the lawnmower paths and the tour.

According to the disclosure a non-transitory computer-readable medium storing instructions that, when executed by one or more processors, cause the one or more processors to perform operations comprising receiving an environment representation for a robot coverage task, receiving a set of candidate orientations and a minimum coverage ratio, generating candidate rectangular sectors within the environment representation at the candidate orientations, greedily selecting a set of sectors by repeatedly adding a candidate sector that maximizes a marginal increase in a submodular coverage function representing area covered by a union of the selected sectors and outputting the selected set of sectors when the submodular coverage function indicates coverage at least equal to the minimum coverage ratio.

According to the disclosure, the non-transitory computer-readable medium of claim 26, wherein the operations further comprise applying an erosion radius parameter to allow bounded overlap among selected sectors. The non-transitory computer-readable medium of claim 26, wherein the operations further comprise merging adjacent sectors when a merged coverage line count does not exceed an unmerged coverage line count.

According to the disclosure, the non-transitory computer-readable medium of claim 26, wherein the operations further comprise generating a coverage path by selecting a lawnmower path for each sector and connecting the lawnmower paths using transition paths. The transition paths are computed using obstacle-aware planning in the environment representation.

Steps may be reordered unless a particular order is required. “Determining” may include computing, selecting, receiving, or accessing. “Based on” means based at least on.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Portions of this application, including the specification and/or claims, may have been drafted using AI-assisted tools under the direction and supervision of a human practitioner. All inventive contributions are attributable to the listed inventors.

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A method for generating a decomposition of an environment for robot coverage planning, the method comprising:
obtaining an environment representation defining a coverable region in a two-dimensional workspace;
obtaining a coverage tool width associated with a robot configured to traverse the environment;
obtaining a plurality of candidate orientations for coverage;
generating, for at least one of the candidate orientations, a plurality of candidate rectangular sectors each contained within the coverable region and oriented according to the candidate orientation;
iteratively selecting, by one or more processors, candidate rectangular sectors to form a sector set by repeatedly choosing a candidate rectangular sector that maximizes a marginal increase in a sector coverage function representing area of the environment covered by a union of sectors in the sector set; and
terminating the iteratively selecting when the sector coverage function indicates coverage of at least a minimum coverage ratio of the environment;
wherein the sector coverage function is submodular with respect to the candidate rectangular sectors.

2. The method of claim 1, wherein the minimum coverage ratio is a parameter γ∈(0,1]and terminating comprises terminating when covered area is at least γtimes a total area of the environment.

3. The method of claim 1, wherein the plurality of candidate orientations includes orientations derived from edges of boundaries or obstacles in the environment representation.

4. The method of claim 1, wherein generating the plurality of candidate rectangular sectors comprises, for each candidate orientation, computing a largest-area rectangular sector inside the environment at the candidate orientation.

5. The method of claim 1, wherein iteratively selecting comprises recomputing candidate rectangular sectors relative to a remaining uncovered portion of the environment.

6. The method of claim 1, further comprising controlling overlap between sectors using an erosion radius parameter β.

7. The method of claim 6, wherein controlling overlap comprises removing from a remaining-environment set a Minkowski difference of a selected sector and a disk having radius β, such that subsequently selected sectors are permitted to overlap the selected sector by an amount based on β.

8. The method of claim 6, wherein β=0 causes the selected sectors to be non-overlapping.

9. The method of claim 1, further comprising, after forming the sector set, performing local merges among at least two neighboring sectors to reduce a number of sectors.

10. The method of claim 9, wherein performing local merges comprises selecting a first sector and a second sector and merging the first sector into the second sector when a number of coverage lines required to cover a union of the first and second sectors along an orientation of the second sector is less than or equal to a sum of coverage lines required to cover the first sector and the second sector individually.

11. The method of claim 1, further comprising generating, for each selected sector, a lawnmower coverage path comprising parallel coverage lines oriented along a longest edge of the selected sector.

12. The method of claim 11, further comprising selecting, for at least one selected sector, one of two alternative lawnmower traversal patterns that differ in connections between coverage lines.

13. The method of claim 11, further comprising generating a coverage tour that connects lawnmower coverage paths of the selected sectors.

14. The method of claim 13, wherein generating the coverage tour comprises formulating a generalized traveling salesperson problem (GTSP) in which each sector corresponds to a group of vertices representing candidate directed sector-coverage traversals.

15. The method of claim 13, further comprising computing at least one transition path between an end of a lawnmower coverage path in a first sector and an end of a lawnmower coverage path in a second sector using obstacle-aware planning.

16. The method of claim 15, wherein the obstacle-aware planning comprises visibility-graph planning.

17. The method of claim 13, further comprising computing transition costs using a robot motion model that penalizes stopping and turning by modeling piecewise acceleration toward a maximum velocity.

18. The method of claim 1, wherein the environment representation comprises a polygonal free-space representation including boundaries and holes corresponding to obstacles.

19. The method of claim 1, wherein the robot is a cleaning robot and the coverage tool width corresponds to a cleaning head width.

20. A system for robot coverage planning, comprising:
one or more processors; and
one or more non-transitory memories storing instructions that, when executed by the one or more processors, cause the system to:
obtain an environment representation defining a coverable region in a two-dimensional workspace;
obtain a coverage tool width associated with a robot;
obtain a plurality of candidate orientations;
generate candidate rectangular sectors oriented according to the plurality of candidate orientations and contained within the coverable region;
select a sector set by iteratively adding a candidate rectangular sector that maximizes a marginal increase in a submodular sector coverage function corresponding to covered area of a union of sectors in the sector set; and
stop the iteratively adding when the sector set covers at least a minimum coverage ratio of the environment.
